(19) United States
(12) Patent Application Publication
(10) Pub. No.: US 2002/0175583 A1
(43) Pub. Date: Nov. 28, 2002

(54) Permanent magnet type rotating electrical machine and air conditioner using it

(76) Inventors: Satoshi Kikuchi, Hitachi (JP); Haruo Koharagi, Juo (JP); Shinichi Wakui, Hitachi (JP); Mamoru Kimura, Hitachi (JP); Ryoichi Takahata, Hitachi (JP); Kohji Maki, Hitachi (JP); Kazuo Tahara, Hitachi (JP); Kenji Miyata, Hitachinaka (JP); Masashi Kitamura, Mito (JP); Miyoshi Takahashi, Hitachi (JP)

Correspondence Address: DICKSTEIN SHAPIRO MORIN & OSHINSKY LLP, 2101 L STREET NW, WASHINGTON, DC, 20037-1526, US

(21) Appl. No.: 09/969,629

(22) Filed: Oct. 4, 2001

(30) Foreign Application Priority Data
May 25, 2001 (JP) 2001-156323

(51) Int. Cl. H02K 16/00; H02K 16/02; H02K 21/12; H02K 1/22

(52) U.S. Cl. 310/156.56; 310/261; 310/114

(57) ABSTRACT

A permanent magnet type rotating electrical machine capable of reducing core loss due to armature reaction magnetic flux and making an effective use of reluctance torque. A permanent magnet type rotating electrical machine comprising a first rotor core equipped with a permanent magnet stored in a permanent magnet insertion hole, and a second rotor core having a reluctance magnetic circuit, wherein a concave portion is provided between poles in the vicinity of the outer surface of the first rotor core, and a flux barrier constituting the reluctance magnetic circuit of the second rotor core is arranged in a form different from the magnet insertion hole, whereby the magnetic path of the armature reaction magnetic flux is defined, and a permanent magnet type rotating electrical machine delivering a large output is obtained by making an effective use of reluctance torque.

### BACKGROUND OF THE INVENTION

1. Field of the Invention

The present invention relates to a permanent magnet type rotating electrical machine having a rotor equipped with permanent magnets for field, and particularly to a permanent magnet type rotating electrical machine mounted on the compressor of an air conditioner.

2. Prior Art

According to the disclosure of the Japanese Application Patent Laid-Open Publication No. Hei 11-285188, the rotor core in a permanent magnet type rotating electrical machine comprises a first core producing only the reluctance torque and a second core for generating at least magnet torque wherein permanent magnets in the number corresponding to the number of poles are embedded along the outer periphery of the core at an equally spaced interval.

The Japanese Application Patent Laid-Open Publication No. 2000-37052 discloses a permanent magnet type rotating electrical machine wherein a permanent magnet rotor is located at the center and a reluctance torque rotor is arranged on each of both ends.

To use the reluctance torque, it is necessary to generate the armature reaction magnetic flux to be created by armature wiring. However, all of the prior arts have the problem that there is an increase in core loss due to armature reaction magnetic flux even if reluctance torque is produced, and the output of permanent magnet type rotating electrical machine cannot be improved.

### SUMMARY OF THE INVENTION

The object of the present invention is to provide a permanent magnet type rotating electrical machine capable of suppressing the increase of core loss due to armature reaction magnetic flux and making an effective use of reluctance torque.

To improve the output of the permanent magnet type rotating electrical machine, an effective use of reluctance torque is essential. Reluctance torque relates to the magnitude of armature reaction magnetic flux produced by the current supplied to the armature wiring. Armature reaction magnetic flux passes through the interpolar core positioned between poles of the permanent magnet of the rotor core.

However, the inter-polar core also passes through the magnetic flux from the permanent magnet, so it is placed in the magnetically saturated area so that the armature reaction magnetic flux cannot easily pass through. Further, in addition to the fundamental wave magnetic flux, harmonic wave magnetic flux occurs to the magnetic flux created by armature wiring. If harmonic wave magnetic flux created by armature wiring passes through the interpolar core placed in the magnetically saturated area, core loss is increased, with the result that effective use of reluctance torque is interfered.

The first characteristic of the present invention is found in that, in the first rotor core containing permanent magnets in the permanent magnet insertion holes, a concave portion is provided between poles in the vicinity of the outer surface on the first rotor core, and the gap length of the magnetic path on the q-axis side is greater than that on the d-axis side, with the result that passage of the armature reaction magnetic flux is made difficult.

On the other hand, the second rotor core as a reluctance torque rotor is provided with flux barriers against d-axis magnetic flux in a form different from that of permanent magnet insertion holes of the first rotor core.

The arrangement described above ensures that the armature reaction magnetic flux cannot easily pass through the first rotor core with the permanent magnet embedded therein, because of the concave portion provided between poles in the vicinity of the outer surface, whereas armature reaction magnetic flux can easily pass through the interpolar core of the second rotor core.

The second rotor core can provide an effective flux barrier against the d-axis magnetic flux. Since there is no permanent magnet, its magnetic flux density of the interpolar core is low, and a big armature reaction magnetic flux is produced by a small amount of armature current.

This results in a small amount of armature current. This results in a small core loss due to armature reaction magnetic flux. This makes it possible to provide a permanent magnet type rotating electrical machine capable of improving output by an effective use of reluctance torque.

The second characteristic of the present invention is found in that a concave portion is provided between poles in the vicinity of the outer surface, and that the first rotor core with permanent magnets embedded therein and the second rotor core having multiplex arch-shaped (U-shaped) flux barriers are used in combination.

The third characteristic of the present invention is found in that a concave portion is provided between poles in the vicinity of the outer surface, and that the first rotor core with permanent magnets embedded therein and the second rotor core designed in a switched reluctance structure with a salient pole located on the q-axis side are used in combination.

The fourth characteristic of the present invention is found in that a concave portion is provided between poles in the vicinity of the outer surface, and that the first rotor core with permanent magnets embedded therein in a straight line, U-shaped (arched) or V-shaped configuration and the second rotor core with a flux barrier arranged on the q-axis side are used in combination.

The fifth characteristic of the present invention lies in that a concave portion is provided between poles in the vicinity of the outer surface. It is also found in the arrangement of the first rotor core with permanent magnets embedded therein, and the second rotor core where flux barriers are on both ends of the shaft so as to hold said first rotor core in-between.

The sixth characteristic of the present invention lies in the arrangement of a second rotor core provided with flux barriers and a first rotor core characterized in that a concave portion is provided between poles in the vicinity of the outer surface so as to hold the second rotor core in-between from both shaft ends and permanent magnets are embedded therein.

Other characteristics of the present invention will be clarified by the following description of the embodiments:

### BRIEF DESCRIPTION OF THE DRAWINGS

FIG. 1 is a perspective view representing a rotor configuration as the first embodiment of a permanent magnet type rotating electrical machine according to the present invention;

FIG. 2 is a cross sectional view in the radial direction representing the rotor core configuration given in FIG. 1;

FIG. 3 is a cross sectional view in the radial direction representing a first rotor core 1 as the first embodiment according to the present invention;

FIG. 4 is a cross sectional view in the radial direction representing a second rotor core 2 as the first embodiment according to the present invention;

FIG. 5 is a perspective view representing the rotor core configuration as the second embodiment according to the present invention;

FIG. 6 is a cross sectional view representing the rotor core configuration given in FIG. 5;

FIG. 7 is a cross sectional view in the radial direction representing the rotor core configuration as the third embodiment according to the present invention;

FIG. 8 is a cross sectional view in the radial direction representing the rotor core configuration as the fourth embodiment according to the present invention;

FIG. 9 is a cross sectional view in the radial direction representing the rotor core configuration as the fifth embodiment according to the present invention;

FIG. 10 is a cross sectional view in the radial direction representing the rotor core configuration as the sixth embodiment according to the present invention;

FIG. 11 is a cross sectional view in the radial direction representing the rotor core configuration as the seventh embodiment according to the present invention;

FIG. 12 is a cross sectional view in the radial direction representing the rotor core configuration as the eighth embodiment according to the present invention;

FIG. 13 is a cross sectional view in the radial direction representing the rotor core configuration as the ninth embodiment according to the present invention;

FIG. 14 is a cross sectional view in the radial direction representing the rotor core configuration as the tenth embodiment according to the present invention;

FIG. 15 is a cross sectional view in the radial direction representing the rotor core configuration as the eleventh embodiment according to the present invention;

FIG. 16 is a cross sectional view in the radial direction representing the rotor core configuration as the twelfth embodiment according to the present invention;

FIG. 17 is a perspective view representing the rotor configuration as the thirteenth embodiment according to the present invention;

FIG. 18 is a perspective view representing the rotor configuration as the fourteenth embodiment according to the present invention;

FIG. 19 is a perspective view representing the rotor configuration as the fifteenth embodiment according to the present invention;

FIG. 20 is a perspective view representing the rotor configuration as the sixteenth embodiment according to the present invention; and

FIG. 21 is a block diagram representing the refrigeration cycle of an air conditioner as the seventeenth embodiment according to the present invention.

### DETAILED DESCRIPTION OF THE INVENTION

The following describes the embodiments of the permanent magnet type rotating electrical machine according to the present invention with reference to drawings:

<First Embodiment>

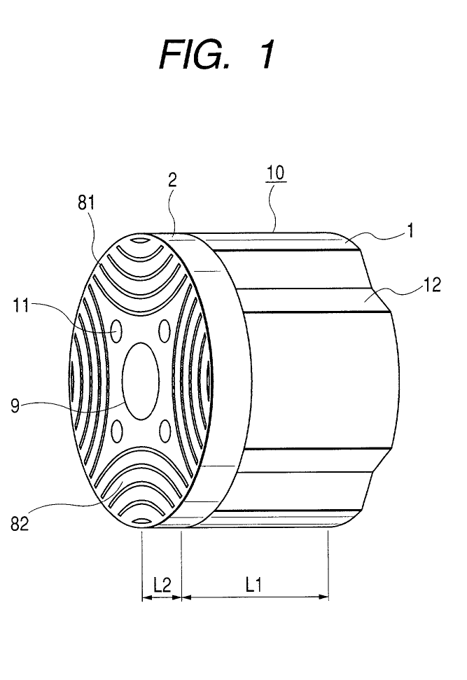

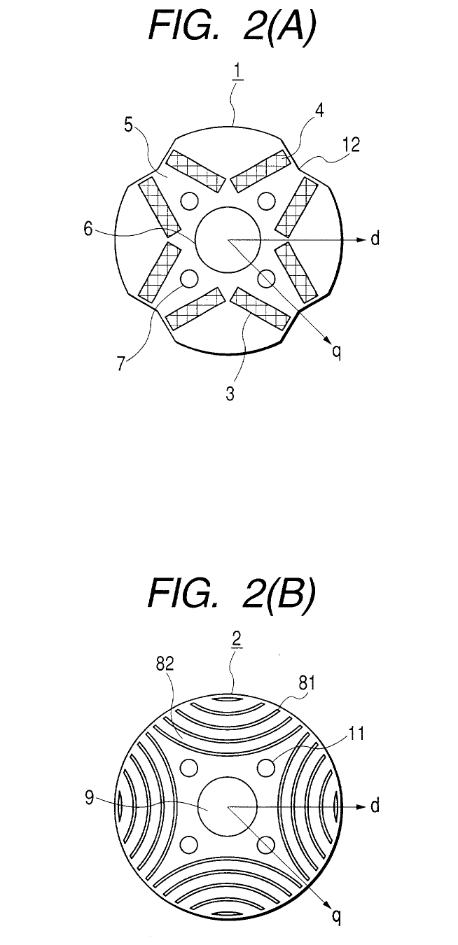

FIG. 1 is a perspective view representing a rotor configuration as the first embodiment of a permanent magnet type rotating electrical machine according to the present invention. FIG. 2 is a cross sectional view in the radial direction representing the rotor core configuration given in FIG. 1.

In the drawings, a rotor 10 comprises a first rotor core 1 split in the axial direction and a second rotor core 2, and is arranged in such a way that the length of the first rotor core 1 in the axial direction L1 is greater than that of the second rotor core 2 in the axial direction L2. The first rotor core 1 contributes mainly to the generation of motoring torque by the permanent magnet type synchronous motor, while the second rotor core 2 contributes to the generation of reluctance torque by a reluctance motor.

The first rotor core 1 comprises a rare earth permanent magnet 4 (four-pole type is shown here) arranged in the convex V-shaped permanent magnet insertion hole 3 with respect to the shaft of the rotor 10, an interpolar core 5, a rotor shaft hole 6 for being fitted to the shaft (not illustrated) and a river hole 7 for securing the first rotor core 1.

The permanent magnet 4 is preferred to be a rare earth magnet represented by neodymium-iron-boron or samarium cobalt magnet. A less costly ferritic group magnet can be used for this purpose. The permanent magnet 4 is inserted, and the central direction of this letter V is referred to as d-axis, which serves as a magnetic flux axis. The magnetic flux axis 90 degrees different from this d-axis in terms of electric angle is referred to as q-axis, which serves as an armature reaction axis. In order that the first rotor core 1 does not allow the armature reaction magnetic flux to pass through, a concave portion 12 is formed by slightly cutting the interpolar core 5 in a letter V in the vicinity of the rotor surface on the q-axis side.

As is clear from the drawing, the magnetic path gap of the first rotor core 1 is small with respect to d-axis magnetic flux, and a sufficient amount of motoring torque is generated as a synchronous motor. Not only that, magnetic path gap is increased to cope with q-axis magnetic flux due to armature reaction. So the flux is not easily accepted, and q-axis magnetic flux due to armature reaction is led toward the second rotor core 2 side.

The second rotor core 2 has a reluctance magnetic circuit 8 comprising a convex multiplex arch-shaped (U-shaped) flux barrier 81 with respect to the shaft of rotor 10—a different configuration from that of the permanent magnet insertion hole 3—and a copper plate 82. It also has a rotor shaft hole 9 for fitting with the shaft (not illustrated) and a river hole 11 for securing the second rotor core 2.

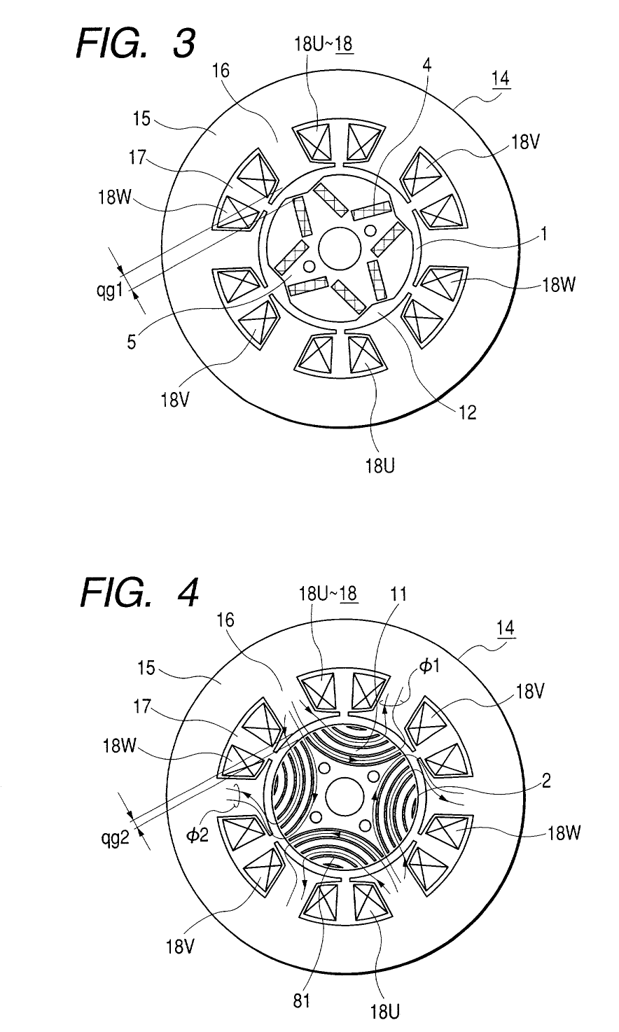

No concave portion is formed the interpolar core 13 of the second rotor core 2. It has a truly round outer periphery. Thus, armature reaction magnetic flux can easily pass through the interpolar core 13 of the second rotor core 2. This will be described in greater details with reference to FIG. 3.

FIG. 3 is a cross sectional view in the radial direction representing a first rotor core 1 as the first embodiment of a permanent magnet type rotating electrical machine according to the present invention. FIG. 4 is a cross sectional view in the radial direction representing a second rotor core 2 as the first embodiment of the permanent magnet type rotating electrical machine according to the present invention.

In FIGS. 3 and 4, the stators 14 are the same, and multiple tees 16 and slots 17 are provided in the stator core 15. Armature wiring 18 in a concentrated winding is provided in the slot 17 to as to surround the tees 16; namely, U-phase winding 18U, V-phase winding 18V and W-phase winding 18W are provided in a concentrated winding.

When attention is paid to the rotor, passage of armature reaction magnetic flux through the interpolar core 5 of the first rotor core 1 is difficult according to the arrangement of the first rotor core 1 shown in FIG. 3. In other words, according to the arrangement of the first rotor core 1 of FIG. 3, the length of the gap on the q-axis side is as large as qg1. The interpolar core 5 is placed in the magnetically saturated area by the permanent magnet 4, and passage of armature reaction magnetic flux is made difficult.

By contract, when the arrangement of the second rotor core 2 shown in FIG. 4 is used, passage of the armature reaction magnetic flux through the interpolar core 13 of the second rotor core 2 is easy. In other words, according to the arrangement of the second rotor core 2 given in FIG. 4, the length of gap on the q-axis side is as small as qg2.

Since there is no permanent magnet, passage of armature reaction magnetic flux Φ1 and flux Φ2 through the interpolar core 13 is made easy. Especially, the reluctance magnetic circuit 8 comprising multiplex arch-shaped (U-shaped) flux barriers 81 and ribs 82 allows easy passage of armature reaction magnetic flux Φ and flux Φ2 (q-axis magnetic flux).

To cope with the d-axis magnetic flux, a flux barrier almost at a right angle to the direction of magnetic flux at any position is formed, thereby providing virtually ideal barrier effects. On the second rotor core 2 side, accordingly, big armature reaction (q-axis) magnetic flux Φ1 and flux Φ2 are generated by a small armature current. This makes it possible to make an effective use of reluctance torque to get a permanent magnet type rotating electrical machine characterized by a large output.

Thus, it is possible to provide a permanent magnet type rotating electrical machine which supplies a sufficient torque with the aid of reluctance torque, while saving the permanent magnet accompanied by high price and recycling problems.

<Second Embodiment>

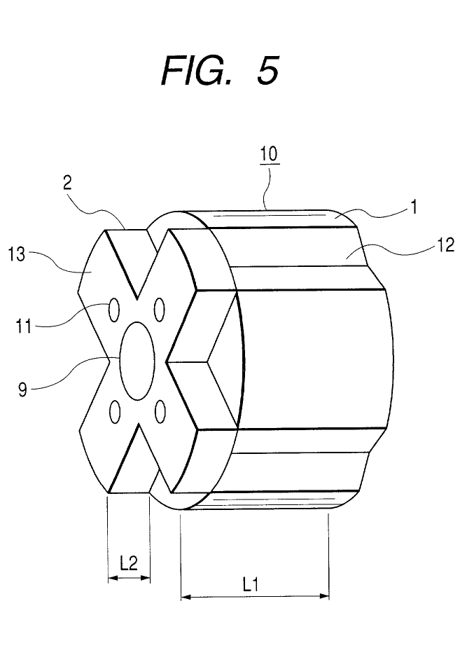

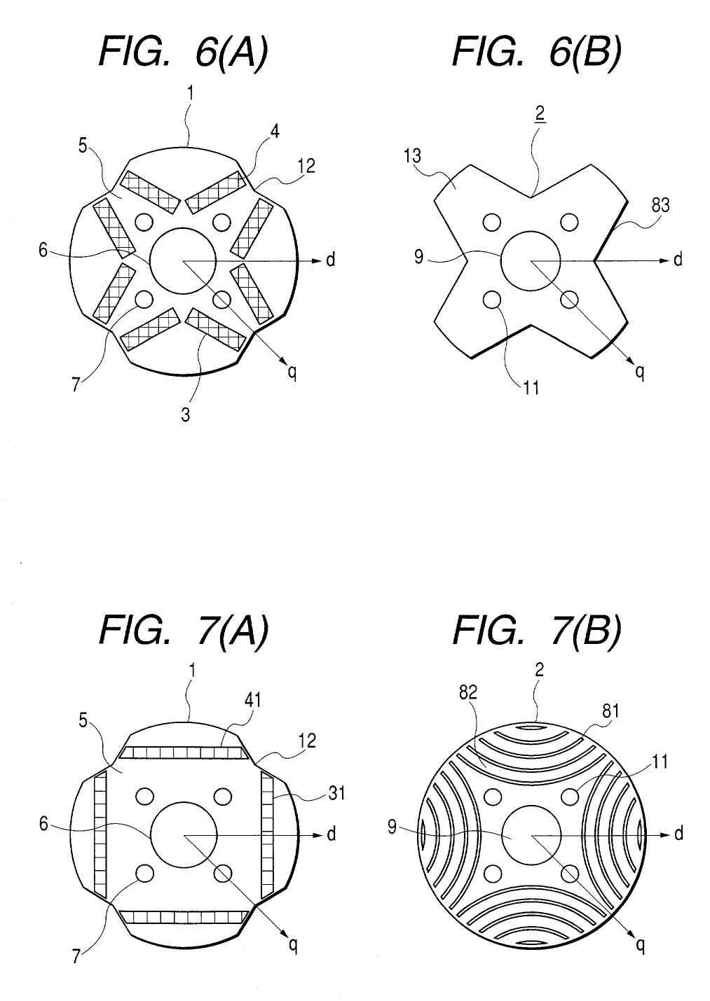

FIG. 5 is a perspective view representing the rotor core configuration as the second embodiment of a permanent magnet type rotating electrical machine according to the present invention. FIG. 6 is a cross sectional view representing the rotor core configuration given in FIG. 5.

In the drawings, the same components as those in FIGS. 1 to 4 will be assigned with the same numerals to avoid redundant explanation. Similarly to FIGS. 1 to 4, rotor 10 comprises a first rotor core 1 split in the axial direction and a second rotor core 2, and is arranged in such a way that the length of the first rotor core 1 in the axial direction L1 is greater than that of the second rotor core 2 in the axial direction L2. The first rotor core 1 contributes mainly to the generation of motoring torque by the permanent magnet type synchronous motor, while the second rotor core 2 contributes to the generation of reluctance torque by a reluctance motor.

The difference from FIGS. 1 to 4 is that the second rotor core 2 is designed in a switched reluctance structure with a salient pole 13 located on the q-axis side, and that a flux barrier is formed by a large concave portion 83 to cope with d-axis magnetic flux.

This arrangement also provides the same effect as described in the first embodiment.

<Third Embodiment>

FIG. 7 is a cross sectional view in the radial direction representing the rotor core configuration as the third embodiment of a permanent magnet type rotating electrical machine according to the present invention.

In the drawing, the same components as those in FIG. 2 will be assigned with the same numerals to avoid redundant explanation. The difference from FIG. 2 is that a permanent magnet 41 made of one flat plate is inserted into the permanent magnet insertion hole 31 of a straight line in the first rotor core 1.

This arrangement also provides the same basic performance as that described in the first embodiment.

<Fourth Embodiment>

FIG. 8 is a cross sectional view in the radial direction representing the rotor core configuration as the fourth embodiment of a permanent magnet type rotating electrical machine according to the present invention.

In the drawing, the same components as those in FIGS. 6 and 7 will be assigned with the same numerals to avoid redundant explanation. The first rotor core 1 is the same as that in FIG. 7, and the second rotor core 2 has the same structure as that in FIG. 6. This arrangement also provides the same basic performance as that described in the first embodiment.

<Fifth Embodiment>

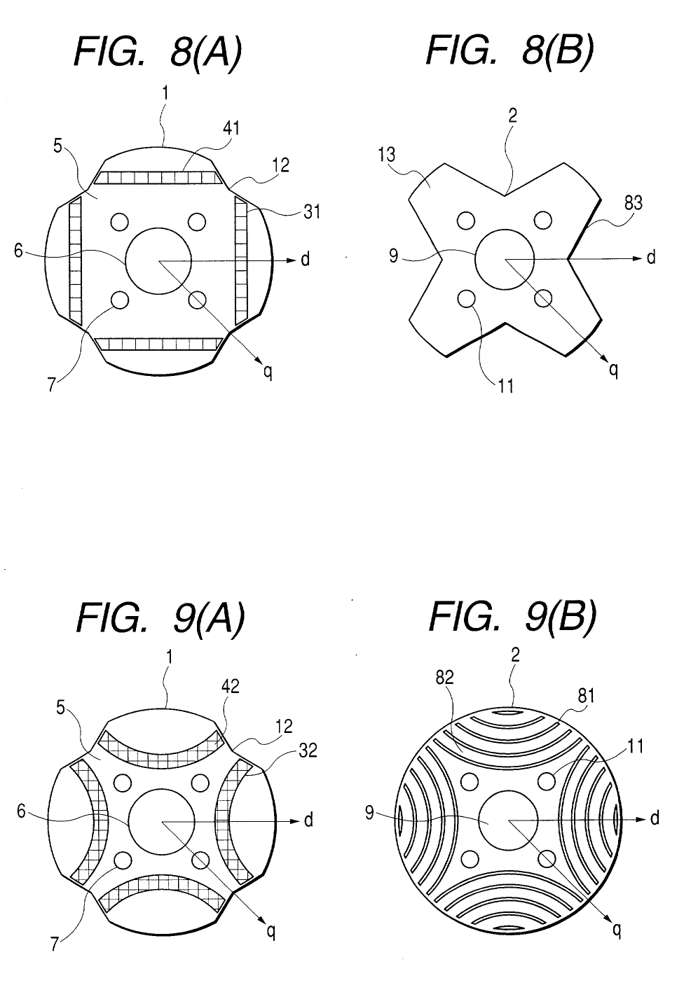

FIG. 9 is a cross sectional view in the radial direction representing the rotor core configuration as the fifth embodiment of a permanent magnet type rotating electrical machine according to the present invention.

In the drawing, the same components as those in FIG. 2 will be assigned with the same numerals to avoid redundant explanation. The difference from FIG. 2 is that a U-shaped (arched) permanent magnet 42 is inserted into the U-shaped (arched) permanent magnet insertion hole 32 in the first rotor core 1.

This arrangement also provides the same basic performance as that described in the first embodiment.

<Sixth Embodiment>

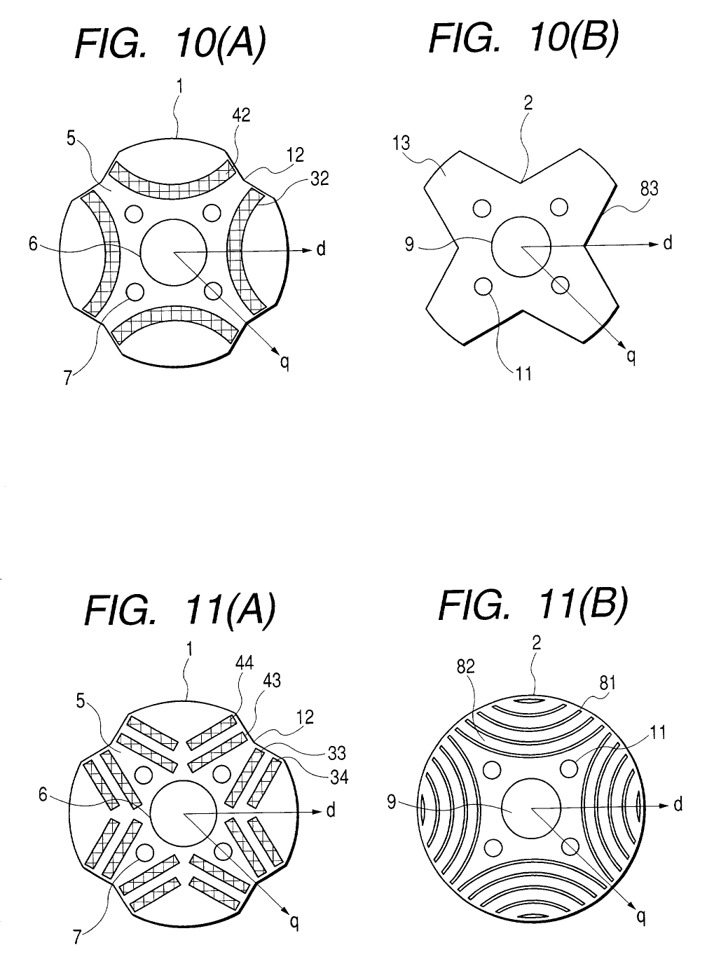

FIG. 10 is a cross sectional view in the radial direction representing the rotor core configuration as the sixth embodiment of a permanent magnet type rotating electrical machine according to the present invention.

In the drawing, the same components as those in FIGS. 6 and 9 will be assigned with the same numerals to avoid redundant explanation. The first rotor core 1 has the same structure as that in FIG. 9, while the second rotor core 2 has the same structure as that in FIG. 6. This arrangement also provides the same basic performance as that described in the first embodiment.

<Seventh Embodiment>

FIG. 11 is a cross sectional view in the radial direction representing the rotor core configuration as the seventh embodiment of a permanent magnet type rotating electrical machine according to the present invention.

In the drawing, the same components as those in FIG. 2 will be assigned with the same numerals to avoid redundant explanation. The difference from FIG. 2 is that permanent magnets 43 and 44 are inserted into permanent magnet insertion holes 33 and 34 in the first rotor core 1, and permanent magnets 43 and 44 are arranged to form a dual V-shape.

This arrangement also provides the same basic performance as that described in the first embodiment.

<Eighth Embodiment>

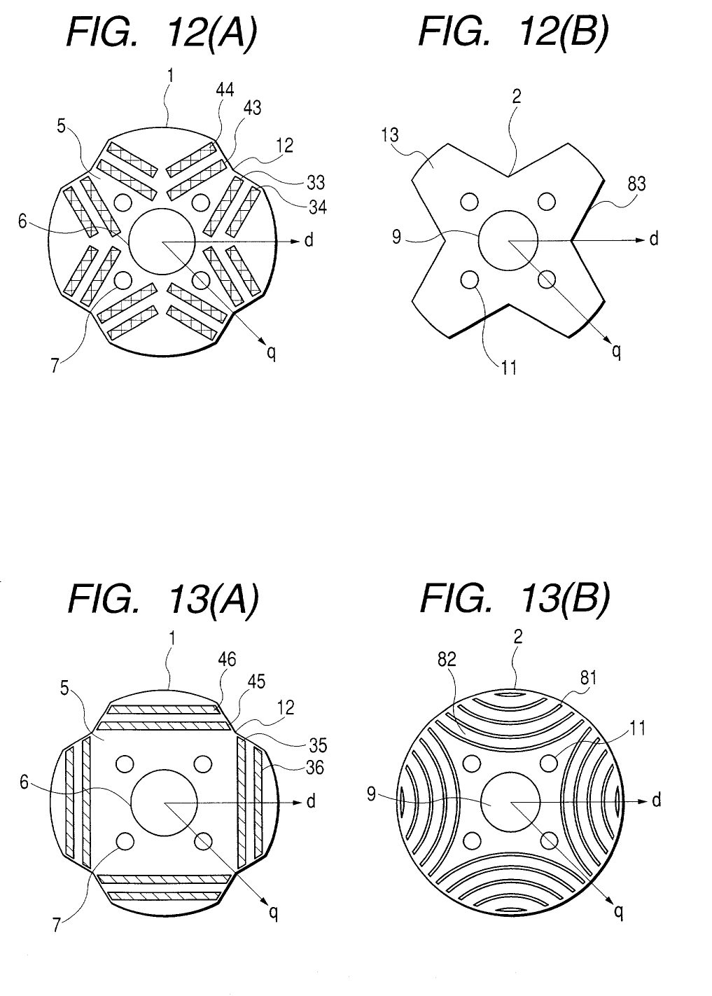

FIG. 12 is a cross sectional view in the radial direction representing the rotor core configuration as the eighth embodiment of a permanent magnet type rotating electrical machine according to the present invention.

In the drawing, the same components as those in FIGS. 6 and 7 will be assigned with the same numerals to avoid redundant explanation. The first rotor core 1 has the same structure as that in FIG. 11, while the second rotor core 2 has the same structure as that in FIG. 6. This arrangement also provides the same basic performance as that described in the first embodiment.

<Ninth Embodiment>

FIG. 13 is a cross sectional view in the radial direction representing the rotor core configuration as the ninth embodiment of a permanent magnet type rotating electrical machine according to the present invention.

In the drawing, the same components as those in FIG. 2 will be assigned with the same numerals to avoid redundant explanation. The difference from FIG. 2 is that permanent magnets 45 and 46 are inserted into permanent magnet insertion holes 35 and 36 formed in dual straight lines in the first rotor core 1, and permanent magnets 45 and 46 are made of two flat plate magnets.

This arrangement also provides the same basic performance as that described in the first embodiment.

<Tenth Embodiment>

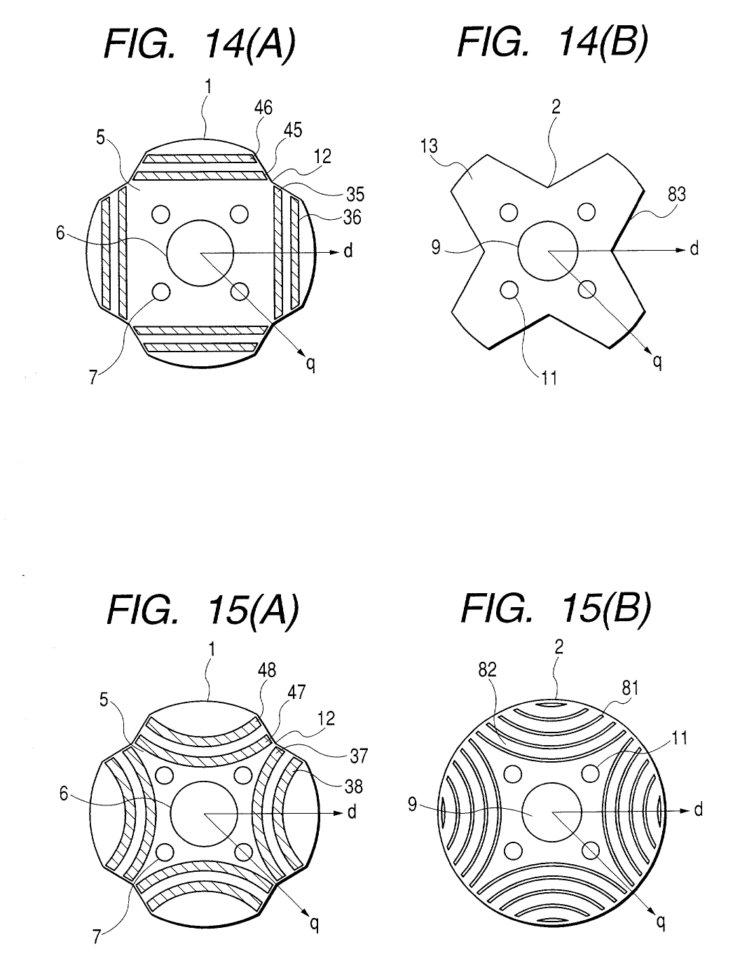

FIG. 14 is a cross sectional view in the radial direction representing the rotor core configuration as the tenth embodiment of a permanent magnet type rotating electrical machine according to the present invention.

In the drawing, the same components as those in FIGS. 6 and 13 will be assigned with the same numerals to avoid redundant explanation. The first rotor core 1 is the same as that in FIG. 13, and the second rotor core 2 has the same structure as that in FIG. 6. This arrangement also provides the same basic performance as that described in the first embodiment.

<Eleventh Embodiment>

FIG. 15 is a cross sectional view in the radial direction representing the rotor core configuration as the eleventh embodiment of a permanent magnet type rotating electrical machine according to the present invention.

In the drawing, the same components as those in FIG. 2 will be assigned with the same numerals to avoid redundant explanation. The difference from FIG. 2 is that permanent magnets 47 and 48 are inserted into permanent magnet insertion holes 37 and 38 in the first rotor core 1, and permanent magnets 47 and 48 are arranged to form a dual U-shape (arched shape). This arrangement also provides the same basic performance as that described in the first embodiment.

<Twelfth Embodiment>

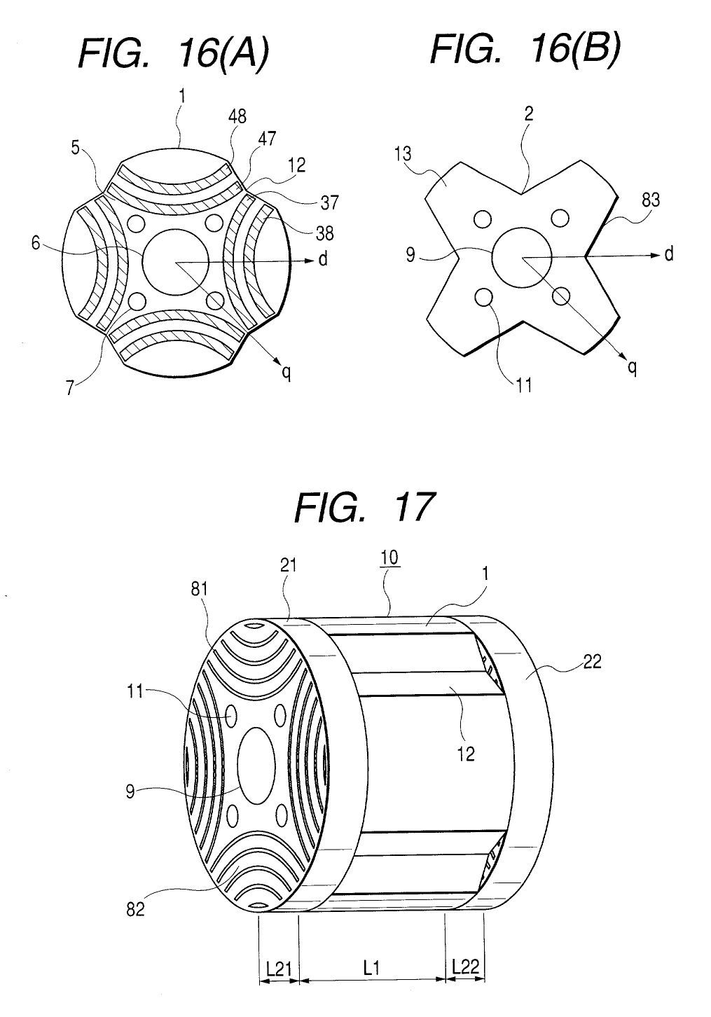

FIG. 16 is a cross sectional view in the radial direction representing the rotor core configuration as the twelfth embodiment of a permanent magnet type rotating electrical machine according to the present invention.

In the drawing, the same components as those in FIGS. 6 and 15 will be assigned with the same numerals to avoid redundant explanation. The first rotor core 1 has the same structure as that in FIG. 15, while the second rotor core 2 has the same structure as that in FIG. 6. This arrangement also provides the same basic performance as that described in the first embodiment.

<Thirteenth Embodiment>

FIG. 17 is a perspective view representing the rotor configuration as the thirteenth embodiment of a permanent magnet type rotating electrical machine according to the present invention. In the rotor shown in the drawing, the same components as those in FIG. 1 will be assigned with the same numerals to avoid redundant explanation.

The difference from FIG. 1 is that the rotor 10 is arranged in such a way that the rotor cores 21 and 22 hold the first rotor core in-between from both ends of the shaft, where the length of the first rotor core 1 in the axial direction L1 is arranged to be greater than the composite length of the second rotor cores 21 and 22 in the axial direction (L21+L22). This arrangement also provides the same basic performance as that described in the first embodiment.

<Fourteenth Embodiment>

FIG. 18 is a perspective view representing a rotor configuration as the fourteenth embodiment of a permanent magnet type rotating electrical machine according to the present invention. In the rotor shown in the drawing, the same components as those in FIG. 5 will be assigned with the same numerals to avoid redundant explanation.

The difference from FIG. 5 is that the rotor 10 is arranged in such a way that the second rotor cores 23 and 24 hold the first rotor core 1 in-between from both ends of the shaft. The second rotor cores 23 and 24 have the cross sectional view in the radial direction shown in FIG. 6(B).

The length of the first rotor core 1 in the axial direction L1 is arranged to be greater than the composite length of the second rotor cores 23 and 24 in the axial direction (L23+L24). This arrangement also provides the same basic performance as that described in the first embodiment.

<Fifteenth Embodiment>

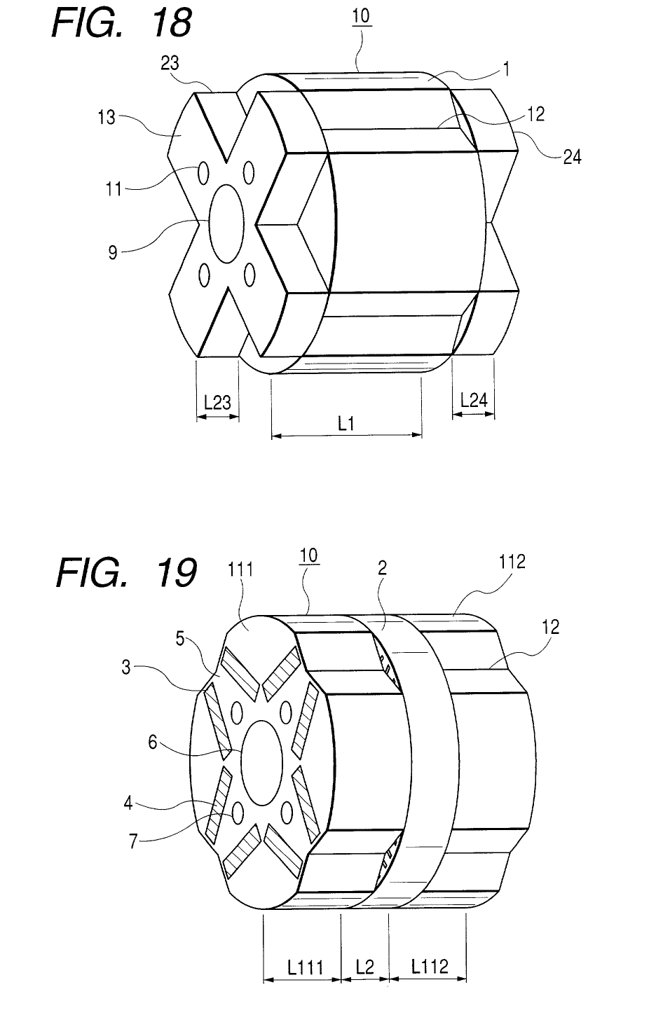

FIG. 19 is a perspective view representing a rotor configuration as the fifteenth embodiment of a permanent magnet type rotating electrical machine according to the present invention.

In the rotor shown in the drawing, the same components as those in FIGS. 1 and 2 will be assigned with the same numerals to avoid redundant explanation. The difference from FIGS. 1 and 2 is that the rotor 10 is arranged in such a way that the first rotor cores 111 and 112 hold the second rotor core 2 in-between from both ends in the axial direction. The first rotor cores 111 and 112 have the cross sectional view in the radial direction shown in FIG. 2(A), while the second rotor core 2 has the configuration shown in FIGS. 1 and 2.

Here the composite length of the first rotor cores 111 and 112 in the axial direction (L111+L112) is arranged to be greater than the length of the second rotor core 2 in the axial direction L2.

In the drawing, the permanent magnet 4 is shown in a single V-shape, but can be arranged in the form of a single or dual straight line or in a arch-shaped (U-shaped) or V-shaped configuration. This arrangement also provides the same basic performance as that described in the first embodiment.

<Sixteenth Embodiment>

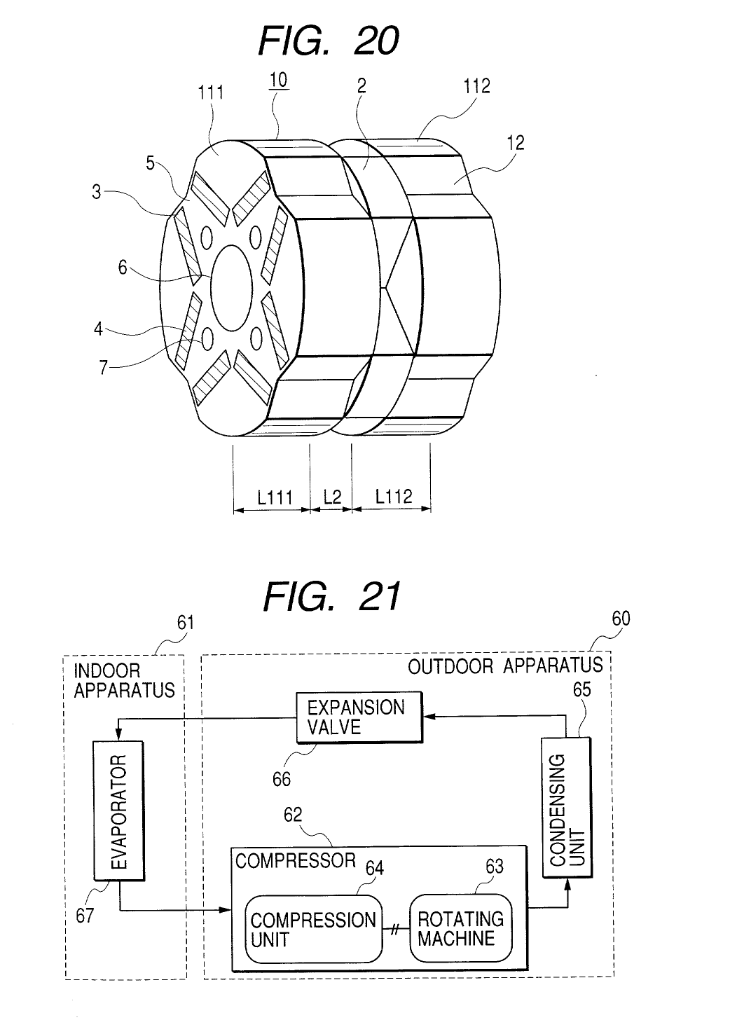

FIG. 20 is a perspective view representing a rotor configuration as the sixteenth embodiment of a permanent magnet type rotating electrical machine according to the present invention. In the rotor shown in the drawing, the same components as those in FIGS. 1 and 5 will be assigned with the same numerals to avoid redundant explanation.

The difference from FIGS. 1 and 5 is that the rotor 10 is arranged in such a way that the first rotor cores 111 and 112 hold the second rotor core 2 in-between from both ends of the shaft.

The first rotor cores 111 and 112 have the cross sectional view in the radial direction shown in FIG. 2 (A), while the second rotor core 2 has the configuration shown in FIGS. 5 and 6. Here the composite length of the first rotor cores 111 and 112 in the axial direction (L111+L112) is arranged to be greater than the length of the second rotor core 2 in the axial direction L2.

In the drawing, the permanent magnet 4 is shown in a single V-shape, but can be arranged in the form of a single or dual straight line or in a arch-shaped (U-shaped) or V-shaped configuration. This arrangement also provides the same basic performance as that described in the first embodiment.

<Seventeenth Embodiment>

FIG. 21 is a block diagram representing the refrigeration cycle of an air conditioner as the seventeenth embodiment of a permanent magnet type rotating electrical machine according to the present invention.

Numeral 60 denotes an outdoor apparatus, 61 an indoor apparatus, and 62 a compressor. The permanent magnet type rotating electrical machine 63 and compressor 64 are sealed in the compressor 62. Numeral 65 denotes a condenser, 66 an expansion valve, and 67 an evaporator.

The freezing cycle allows refrigerant to be circulated in an arrow-marked direction, and the compressor 62 compresses refrigerant. Then heat exchange is performed between the outdoor apparatus 60 comprising the condenser 65 and expansion valve 66, and the indoor apparatus 61 consisting of the evaporator 67, whereby cooling function is performed.

In the following description, the permanent magnet type rotating electrical machine shown in the embodiments given above will be used as permanent magnet type rotating electrical machine 63. This will improve the output of the permanent magnet type rotating electrical machine 63 and will reduce the air conditioner input.

So it has the effect of reducing the emission of CO2 which may cause global warming. It goes without saying that the same effect can be obtained when used in the compressor of the refrigerator and freezer. This is a drawing representing the refrigeration cycle of an air conditioner. In the drawing, 37 denotes an outdoor apparatus, 38 an indoor apparatus and 39 a compressor. The permanent magnet type rotating electrical machine 40 and compressor 41 are sealed in the compressor 39. Numeral 42 denotes a condenser, 43 an expansion valve, and 44 an evaporator.

The freezing cycle allows refrigerant to be circulated in an arrow-marked direction, and compressor 39 compresses refrigerant. Then heat exchange is performed between the outdoor apparatus 37 comprising the condenser 42 and expansion valve 43, and the indoor apparatus 38 consisting of the evaporator 44, whereby cooling function is performed.

According to the embodiments described above, the gap of the first rotor core equipped with permanent magnets on the q-axis side is made longer so that passage of the armature reaction magnetic flux is difficult, whereas the second rotor core 2 having only the reluctance magnetic circuit is arranged to facilitate passage of armature reaction magnetic flux.

This makes it possible to generate a large armature reaction magnetic flux with a small amount of armature current. A permanent magnet type rotating electrical machine capable of delivering a large output can be provided by making an effective use of reluctance torque.

The present invention provides a permanent magnet type rotating electrical machine and air conditioner capable of delivering a large output by making an effective use of reactance torque while saving the permanent magnet.

What is claimed is:

1. A permanent magnet type rotating electrical machine comprising;
a stator provided with armature wiring in multiple slots on a stator core,
a first rotor core split into multiple parts in the axial direction and containing permanent magnets built in multiple permanent magnet insertion holes, and
a second rotor core having a reluctance magnetic circuit;
said permanent magnet type rotating electrical machine characterized in that a concave portion is provided between poles in the vicinity of the outer surface on the first rotor core, and said reluctance magnetic circuit of said second rotor core has on the cross section in the radial direction the flux barriers having different configuration from that of permanent magnet insertion holes of said first rotor core.

2. A permanent magnet type rotating electrical machine comprising;
a stator provided with armature wiring in multiple slots on a stator core,
a first rotor core split into multiple parts in the axial direction and containing permanent magnets built in multiple permanent magnet insertion holes, and
a second rotor core having a reluctance magnetic circuit;
said permanent magnet type rotating electrical machine characterized in that a concave portion is provided between poles in the vicinity of the outer surface on the first rotor core, and said reluctance magnetic circuit of said second rotor core has on the cross section in the radial direction the multiple arch-shaped (U-shaped) flux barriers which are different in configuration from permanent magnet insertion holes of said first rotor core.

3. A permanent magnet type rotating electrical machine comprising;
a stator provided with armature wiring in multiple slots on a stator core,
a first rotor core split into multiple parts in the axial direction and containing permanent magnets built in multiple permanent magnet insertion holes, and
a second rotor core having a reluctance magnetic circuit;
said permanent magnet type rotating electrical machine characterized in that a concave portion is provided between poles in the vicinity of the outer surface on the first rotor core, and said second rotor core is designed in a switched reluctance structure where a salient pole is located on the q-axis side.

4. A permanent magnet type rotating electrical machine comprising;
a stator provided with armature wiring in multiple slots on a stator core,
a first rotor core split into multiple parts in the axial direction and containing permanent magnets built in multiple permanent magnet insertion holes, and
a second rotor core having a reluctance magnetic circuit;
wherein a concave portion is provided between poles in the vicinity of the outer surface;
said permanent magnet type rotating electrical machine further characterized by a combination of;
a stator provided with armature wiring in multiple slots on a stator core,
a first rotor core with permanent magnets embedded therein in a straight line, arch-shaped (U-shaped) or V-shaped configuration, and
a second rotor core with a flux barrier arranged on the q-axis side.

5. A permanent magnet type rotating electrical machine comprising;
a stator provided with armature wiring in multiple slots on a stator core,
a first rotor core split into multiple parts in the axial direction and containing permanent magnets built in multiple permanent magnet insertion holes, and
a second rotor core having a reluctance magnetic circuit;
said permanent magnet type rotating electrical machine further characterized by the arrangement of;
a first rotor core wherein a concave portion is provided between poles in the vicinity of the outer surface, and
a second rotor core wherein flux barriers are provided on both shaft ends so as to hold said first rotor core in-between.

6. A permanent magnet type rotating electrical machine comprising;
a stator provided with armature wiring in multiple slots on a stator core,
a first rotor core split into multiple parts in the axial direction and containing permanent magnets built in multiple permanent magnet insertion holes, and
a second rotor core having a reluctance magnetic circuit;
said permanent magnet type rotating electrical machine characterized in that;
said second rotor core where a flux barrier is formed with respect to the d-axis magnetic path, and
two first rotor cores where a concave portion is provided between poles in the vicinity of the outer surface and where permanent magnets are embedded in a configuration different from that of said flux barrier are arranged in such a way that said second rotor core is held in-between from both shaft ends.

7. A permanent magnet type rotating electrical machine according to any one of claims 1 to 6 characterized in that the axial length of said first rotor core is greater than that of said second rotor core.

8. A compressor arranged to be driven by a permanent magnet type rotating electrical machine according to any one of claims 1 to 6.

9. An air conditioner provided with the compressor according to claim 8.
